(19) United States
(12) Patent Application Publication
(10) Pub. No.: US 2009/0253576 A1
(43) Pub. Date: Oct. 8, 2009

(54) GROWTH MEDIUM

(75) Inventor: Paul Ikin, Victoria (AU)

Correspondence Address: Workman Nydegger;1000 Eagle Gate Tower, 60 East South Temple, Salt Lake City, UT, 84111, US

(73) Assignee: CASETECH AUSTRALIA PTY LTD, Dandenong, Victoria (AU)

(21) Appl. No.: 10/599,533

(22) PCT Filed: Mar. 30, 2005
(86) PCT No.: PCT/AU2005/000460

§ 371 Date: Dec. 18, 2006

(30) Foreign Application Priority Data
Mar. 30, 2004 (AU) 2004901702

(51) Int. Cl. A01N 65/00; C05F 11/00; C05F 11/02

(52) U.S. Cl. 504/101; 71/23; 71/24

(57) ABSTRACT

This invention relates to improved horticultural growth media. In particular, the invention relates to an improved horticultural growth media that includes coconut derived vegetative material, specifically coir.

### FIELD OF INVENTION

This invention relates to an improved horticultural growth medium. In particular, the invention relates to an improved horticultural growth medium that includes coconut derived vegetative material, specifically coir.

### BACKGROUND OF THE INVENTION

In the horticultural industry it is well known to use individual containers for the promotion of seed germination and the subsequent seedling propagation. In general seeds may be germinated either in individual containers or subdivided trays in which there are a number of seeds used. In these applications the individual containers or trays typically contain a mixture of earth, peat, vermiculite or other potting material and the seeds are germinated under controlled greenhouse conditions for quick initial growth. Once germination has occurred seedlings are then typically transplanted to large containers or into the field for further growth.

Growth media are therefore widely used in a number of horticultural applications. Accordingly, in the horticultural industry it is common practice to prepare artificial growth media to be used in this way. Growth media are either prepared in situ by large users of the media or are prepared by specialist companies who sell their products in both the wholesale and retail markets. There are a number of properties that are desirable in mixes of this type. For example the growth medium should have desirable air porosity, suitable water retention properties and sufficient nutrients to sustain plant growth. In addition the product must be easy to use from a logistical standpoint. In other words the amount of additional handling required should be minimised where possible. As would be clear it is not always easy to balance these competing requirements, however developmental work aimed at providing improved growth media is being constantly carried out.

A number of commercial growth media have been developed keeping these criteria in mind. A typical commercial potting mix includes a mixture of coarse sand and an organic material. Mixtures of this type are quite commonly deficient in many nutrients necessary for plant growth and accordingly it is typical to add nutrients required for plant growth to a growth medium of this type.

Historically therefore growth media have typically contained organic materials derived from nature. For example, ingredients that are used extensively in horticultural growth media are peat moss (which in a preferred form is found as sphagnum peat) or waste bark products from the forestry industry. Sphagnum peat is partially decomposed sphagnum moss and is obtained from a number of sources principally Ireland, Holland and Canada. This product is very desirable due to its water retention properties and the like. A problem with peat-based growth media of these types is that peat is a finite resource as it is effectively mined from peat bogs. Accordingly, it is a non-renewable resource and replacements for peat need to be developed.

One material that has found application as a possible replacement for peat is coir dust. Coir is a name given to the fibrous material that constitutes the thick mesocarpal middle layer of the coconut (cocos nucifera). The long fibres of coir are extracted from the coconut husk and utilised in the manufacture of brushes, automobile seats, mattress stuffing, drainage pipe filters, twine and other products. Traditionally the short fibres (2 mm or less) and the dust (0-2 mm) left behind after the longer fibres have been extracted have not found any industrial application. Recently, however it has been found that due to the high porosity of the mesocarpal layer of the coconut the coir dust and short fibres have a correspondingly high porosity. As such they possess many of the properties of peat and can be used as a peat replacer. As coir is a renewable, environmentally friendly resource this makes it attractive as a possible peat replacer. Accordingly a number of horticultural growth medium utilising coir products have been developed. For example one commercially available horticultural medium is 25% coir, 30% compost bark fines, 30% compost horticultural bark, and 15% washed coarse sand with added fertilizer.

A common feature of the commercially available growth media containing coir is that the level of coir is quite low typically being less than 50%. This is because coir dust tends to agglomerate making it a poor growth media on its own as the air porosity of coir dust is quite low as it is very fine and tends to agglomerate. In addition coir available has an inconsistent structure with the level of fines ranging markedly. As such product performance for growth media produced using coir has typically varied wildly making it unsuitable for many uses.

In order to overcome these problems the present formulations containing coir typically require addition of a large number of additional ingredients to provide the final product performance. Whilst overcoming the agglomeration (and subsequent poor overall porosity) the addition of extra ingredients tends to lower the water retention of the mix when compared to pure coir. As such, in order to overcome the problems identified with the use of pure coir, it has been necessary to add further ingredients that partially compromise at least some of the properties of the blend. In addition it makes the manufacturing procedure more cumbersome and environmentally unfriendly. Finally, many of the current formulations are quite bulky and difficult to handle. Thus, even those formulations that achieve high levels of coir were typically bulky and difficult to handle from a logistical standpoint. For example these products are typically expensive to freight and require significant shelf space when on retail display.

Having researched the issue, the applicant found that some of the difficulties identified with the use of coir was due to the fact that the coir typically used in growth media was coir dust with the small particle sizes discussed previously. It is thought that the use of coir with small particle size (such as coir dust having a particle size of 0-2 mm) leads to problems as these materials are typically materials that densely pack leading to reductions in the air porosity of the blend. In order to overcome this difficulty, most users of coir in growth media have blended the coir with the desirable properties with other organic materials to bulk out the coir dust. The difficulty with this approach is it compromises the performance characteristics of the final blend as many of these bulking additives do not add any desirable characteristics to the final blend and are only added to overcome difficulties with the use of coir dust alone.

Accordingly there is a need to develop further improved horticultural growth media based on coir.

### SUMMARY OF INVENTION

The applicant has carried out extensive studies on coir based growth media. The applicant found that the majority of problems were caused by having coir dust as the coir ingredient in growth media of this type. This is necessitated blending of the coir with other ingredients to provide a horticultural growth media with the desired properties.

The applicant has found that an improved horticultural growth medium could be achieved by blending coir of different size grades. This was found to provide a commercial product with suitable levels of air permeability but with improved water retaining capability due to the fact that the total amount of coir in the medium could be significantly raised in comparison to the existing growth media.

Accordingly in a first aspect the present invention provides a growth medium including fine grade coir, and coir having a particle size of at least 3 mm. It is found the blend of fine grade coir with a coir of a larger particle size provide a growth medium with improved characteristics. In particular, this growth medium has improved soil moisture retention as opposed to standard growth media that contain coir but with similar air porosity.

The amount of fine grade coir in the growth medium is preferably 40% or less of the total amount of coir in the medium. In one embodiment the amount of fine grade coir is from 1% to 40%, more preferably from 1% to 25%, even more preferably 5% to 15% of the total amount of coir in the medium. In another embodiment the amount of fine grade coir is from 5% to 40%, more preferably 5% to 20%, even more preferably 10% to 20%, of the total amount of coir in the medium. In one embodiment the amount of fine grade coir is about 5% of the total amount of coir in the medium. In another embodiment the amount of fine grade coir is about 15% of the total amount of coir in the medium.

The coir having a particle size of at least 3 mm can be provided by single grade coir or may be provided in the form of a combination of coir grades. The amount of coir having a particle size of at least 3 mm is preferably 60% or more of the total amount of coir in the medium. In one embodiment the amount of coir having a particle size of at least 3 mm is from 60% to 99%, more preferably from 75% to 99%, most preferably 85% to 95% of the total amount of coir in the medium. In another preferred embodiment the amount of coir having a particle size of at least 3 mm is preferably 60% to 95% of the total amount of coir in the medium, more preferably 80% to 95%, even more preferably 80% to 90% of the total amount of coir in the medium. In one embodiment the amount of coir having a particle size of at least 3 mm is about 85% of the total amount of coir in the medium. In another embodiment the amount of coir having a particle size of at least 3 mm is about 95% of the total amount of coir in the medium.

The coir having a particle size of at least 3 mm is preferably a mixture of 3-6 mm coir and chip and fibre coir.

The medium may contain varied amounts of 3-6 mm grade coir with the amount ranging from 0% to 80% of the total amount of coir in the medium. In one embodiment the medium preferably contains from 10% to 50%, more preferably 15-45%, even more preferably 15% to 40%, most preferably 30% to 40% of the total amount of coir as 3-6 mm grade coir. In another embodiment the medium contains 20% to 50% of the total amount of coir in the medium as 3-6 mm grade coir. In one preferred embodiment the medium contains about 35% of the total amount of coir as 3-6 mm grade coir. In another preferred embodiment the medium contains about 40% of the total amount of coir as 3-6 mm grade coir.

The medium can also contain varied amounts of chip and fibre coir with the amount ranging from 0 to 90% of the total amount of coir in the medium. In one embodiment the amount of chip and fibre coir is from 10% to 89%, more preferably 10 to 79% of the total amount of coir in the medium. In another embodiment the amount of chip and fibre coir is from 15% to 84%, more preferably from 20% to 84%, even more preferably 20% to 69% of the total amount of coir in the medium. In another embodiment the amount of chip and fibre coir is from 20% to 80%, more preferably from 30% to 70%, even more preferably from 40% to 60%, most preferably 50% of the total amount of coir in the medium

In one preferred form of the invention there is provided a growth medium containing coir wherein the coir in the medium is made up of
(a) 1% to 25% fine grade coir, and
(b) 75% to 99% coir having a particle size of at least 3 mm.
In a particularly preferred form of this embodiment the coir in the medium is made up of:
(a) 1% to 25% fine grade coir,
(b) 10% to 50% 3-6 mm grade coir, and
(c) 25% to 89% chip and fibre coir.
In a particularly preferred form of this embodiment the coir in the medium is made up of:
(a) 5% to 15% fine grade coir,
(b) 15% to 40% 3-6 mm grade coir, and
(c) 45% to 80% chip and fibre coir.
In another preferred embodiment there is provided a growth medium containing coir including
10-30 parts of fine grade coir,
20-50 parts 3-6 mm grade coir,
20-75 parts chip and fibre coir,
wherein the total sum of the parts of fine grade coir, 3-6 mm grade coir, and chip and fibre coir add up to 100.
A particularly preferred form of this embodiment includes
15 parts of fine grade coir,
35 parts 3-6 mm grade coir,
50 parts chip and fibre coir,
In another preferred embodiment there is provided a growth medium containing coir including
5-15 parts of fine grade coir,
30 to 50 parts 3-6 mm grade coir, and
40 to 60 parts chip and fibre coir,
wherein the total sum of the parts of fine grade coir, 3-6 mm grade coir, and chip and fibre coir add up to 100,
A particularly preferred form of this embodiment includes
10 parts of fine grade coir,
40 parts 3-6 mm grade coir, and
50 parts chip and fibre coir.
In another preferred embodiment there is provided a growth medium containing coir including
1-10 parts of fine grade coir,
5 to 25 parts 3-6 mm grade coir,
70 to 90 parts chip and fibre coir,
wherein the total sum of the parts of fine grade coir, 3-6 mm grade coir, and chip and fibre coir add up to 100
A particularly preferred form of this embodiment includes
5 parts of fine grade coir,
15 parts 3-6 mm grade coir, and
80 parts chip and fibre coir.
In another preferred embodiment there is provided a growth medium containing coir including
1 to 10 parts of fine grade coir,
15 to 35 parts 3-6 mm grade coir,
60 to 80 parts chip and fibre coir,
wherein the total sum of the parts of fine grade coir, 3-6 mm grade coir, and chip and fibre coir add up to 100,
A particularly preferred form of this embodiment includes
5 parts of fine grade coir,
25 parts 3-6 mm grade coir, and
70 parts chip and fibre coir.
In another preferred embodiment there is provided a growth medium containing coir including
1 to 10 parts of fine grade coir,
30 to 50 parts 3-6 mm grade coir, and
40 to 60 parts chip and fibre coir,
wherein the total sum of the parts of fine grade coir, 3-6 mm grade coir, and chip and fibre coir add up to 100,
A particularly preferred form of this embodiment includes
5 parts of fine grade coir,
40 parts 3-6 mm grade coir,
55 parts chip and fibre coir;

The amount of coir as a percentage of the growth medium can also vary. It is preferred that the total amount of coir in the medium is at least 50% of the medium, more preferably at least 70%, even more preferably at least 90%, even more preferably at least 95%, most preferably at least 97.5%.

The growth media can of course contain a number of other additional components or additives that are typically added to growth media of this type. For example the growth media can include one or more component selected from the group consisting of wetting agents, trace elements, fertilisers, controlled release fertilisers, slow release fertilisers, fungicides, herbicides, insecticides, pigments, pH adjustment agents, buffers, humates, Neem products and fungal additives. It is particularly preferred that the media contains a fertilizer, more preferably a slow release fertilizer or a controlled release fertilizer or a combination thereof, in order to add nutrients to the media. The amount of fertiliser is preferably in the range of from 0.1% to 5%, more preferably in the range of from 1% to 4% most preferably about 3%.

It is also preferred that the media contain a source of magnesium and calcium such as dolomite or lime. It is preferred that the source of magnesium and calcium is present in an amount of from 0.5% to 2% more preferably in an amount of 0.75% to 1.25% most preferably about 1%.

The growth media has preferably been dried. As such it preferably has a moisture content of less than 25%, more preferably less than 18%. It has been found that moisture levels of this type are preferable as they enable the media to be compressed. The growth media is preferably in the form of a compressed block wherein the medium has been compressed by at least a factor of 3, preferably by a factor of 5. The compressed block has significant advantages from a logistical standpoint as it is easy to use and handle and does not require further processing (such as the addition of further additives) prior to use as a growth medium. In addition, when in the block form the media can be transported in a more cost effective manner thus significantly reducing overall cost to the consumer.

### DETAILED DESCRIPTION OF THE INVENTION

In the specification and claims of this application reference is frequently made to numerical ranges. It is intended that reference to a range is an inclusive reference and includes the values at the end points (or one end point if applicable) of the range. For example reference to 60% or more is intended to include 60% itself. In similar fashion reference to 1% to 40% is intended to include the values 1% and 40%.

Coir is the name given to the fibrous material that constitutes the thick mesocarpal middle layer of the coconut fruit (cocos nucifera). The long fibres of coir are extracted from the coconut husk and utilised for the manufacture of brushes, automobile seats, mattress stuffing, drainage pipe filters, twine and other products. Traditionally the short fibres 2 mm or less and dust left behind have accumulated as a waste product for which no industrial use had been discovered. This material due to its resemblance to peat is therefore known as cocopeat.

There are, however, a number of grades of coir available for different applications. Coir dust or cocopeat typically consists of short fibres of 2 mm or less which contains 2-13% of the total and coir like particles ranging in size from granules to fine dust. Coir dust strongly absorbs liquids and gases to impart the honeycomb structure of the mesocarp tissue, which gives the dust a high surface area to unit of volume. The material is also hydrophilic leading to high moisture capacity.

Coir dust and coir fibres are available in a number of grades. Fine grade coir typically has particles in the size of 0-3 mm and incorporates coir dust as well as some larger particles. Superfine grade coir particles are particles of the size of 0-1 mm range. There is also a 3-6 mm grade of coir and, coir may also be available as chip and fibre coir in which the particles are bigger than 6 mm. All of these are readily available commercially.

The applicant has carried out extensive studies on coir based growth medium. The applicant found that the majority of problems were caused by having coir dust as the coir ingredient in growth media of this type. This is necessitated blending of the coir with other ingredients to provide a horticultural growth medium with the desired properties.

The applicant has found that an improved horticultural growth medium could be achieved by blending coir of different size grades. This was found to provide a commercial product with suitable levels of air permeability but with improved water retaining capability due to the fact that the total amount of coir in the medium could be significantly raised in comparison to the existing growth media.

Accordingly in a first aspect the present invention provides a growth medium including fine grade coir, and coir having a particle size of at least 3 mm. It is found the blend of fine grade coir with a coir of a larger particle size provide a growth medium with improved characteristics. In particular, this growth medium has improved soil moisture retention as opposed to standard growth media that contain coir but with similar air porosity.

The amount of fine grade coir in the growth medium is preferably 40% or less of the total amount of coir in the medium. In one embodiment the amount of fine grade coir is from 1% to 40%, more preferably from 1% to 25%, even more preferably 5% to 15% of the total amount of coir in the medium. In another embodiment the amount of fine grade coir is from 5% to 40%, more preferably 5% to 20%, even more preferably 10% to 20%, of the total amount of coir in the medium. In one embodiment the amount of fine grade coir is about 5% of the total amount of coir in the medium. In another embodiment the amount of fine grade coir is about 15% of the total amount of coir in the medium.

The coir having a particle size of at least 3 mm can be provided by a single grade coir or may be provided in the form of a combination of coir grades. The amount of coir having a particle size of at least 3 mm is preferably 60% or more of the total amount of coir in the medium. In one embodiment the amount of coir having a particle size of at least 3 mm is from 60% to 99%, more preferably from 75% to 99%, most preferably 85% to 95% of the total amount of coir in the medium. In another preferred embodiment the amount of coir having a particle size of at least 3 mm is preferably 60% to 95% of the total amount of coir in the medium, more preferably 80% to 95%, even more preferably 80% to 90% of the total amount of coir in the medium. In one embodiment the amount of coir having a particle size of at least 3 mm is about 85% of the total amount of coir in the medium. In another embodiment the amount of coir having a particle size of at least 3 mm is about 95% of the total amount of coir in the medium.

The coir having a particle size of at least 3 mm is preferably a mixture of 3-6 mm coir and chip and fibre coir.

The medium may contain varied amounts of 3-6 mm grade coir with the amount ranging from 0% to 80% of the total amount of coir in the medium. In one embodiment the medium preferably contains from 10% to 50%, more preferably 15-45%, even more preferably 15% to 40%, most preferably 30% to 40% of the total amount of coir as 3-6 mm grade coir. In another embodiment the medium contains 20% to 50% of the total amount of coir in the medium as 3-6 mm grade coir. In one preferred embodiment the medium contains about 35% of the total amount of coir as 3-6 mm grade coir. In another preferred embodiment the medium contains about 40% of the total amount of coir as 3-6 mm grade coir.

The medium can also contain varied amounts of chip and fibre coir with the amount ranging from 0 to 90% of the total amount of coir in the medium. In one embodiment the amount of chip and fibre coir is from 10% to 89%, more preferably 10 to 79% of the total amount of coir in the medium. In another embodiment the amount of chip and fibre coir is from 15% to 84%, more preferably from 20% to 84%, even more preferably 20% to 69% of the total amount of coir in the medium. In another embodiment the amount of chip and fibre coir is from 20% to 80%, more preferably from 30% to 70%, even more preferably from 40% to 60%, most preferably 50% of the total amount of coir in the medium.

The total amount of coir in the medium is preferably at least 50%, even more preferably at least 70%, even more preferably at least 90%, more preferably at least 95%, most preferably at least 97.5%.

The growth medium may also contain a number of other agents that are typically found in growth media of this type. As such the medium may contain other organic matter, peat, pine bark, sawdust, sand and the like. These are typically added where desired as bulking agents and/or to provide other desired properties.

The growth media can of course contain a number of other additional components/additives that are typically added to growth media of this type in order to provide selected performance characteristics. For example the growth media can include at least one component selected from wetting agents, trace elements, fertilisers, controlled release fertilisers, slow release fertilisers, fungicides, herbicides, insecticides, pigments, pH adjustment agents, buffers, a source of magnesium and calcium and the like. It is particularly preferred that the media contains a fertilizer, more preferably a slow release fertilizer, in order to add nutrients to the media. It is particularly preferred that the media contain a source of magnesium and calcium such as dolomite or lime.

The medium may contain any of a number of additives such as fertilizers and trace elements. Any fertilizer well known in the art may be used, however it is preferred that the fertilizer is a slow release fertilizer or a controlled release fertilizer. Any number of well known fertilizers may be used. The amount of fertilizer to be used will vary depending on the desired final product. Nevertheless where a fertiliser is used the typical amount of fertilizer added is in the range of 0.1% to 5%, more preferably 1% to 4%, most preferably about 3%.

The medium may also preferably contain trace elements. Examples of suitable trace elements include copper, zinc, manganese, iron, boron and molybdenum. The amount of trace elements added will be dependent on the desired end use application and can be readily determined by a skilled addressee.

The medium also preferably contains a source of magnesium and calcium. The source may be any suitable type but is preferably dolomite. The level is typically in the range 0.5% to 2%, more preferably 0.75% to 1.25%, most preferably about 1%.

The medium preferably contains a pH control agent, which is typically either Iron Sulphate or lime. The amount of either agent will be determined by the desired pH of the end use application.

The medium also preferably contains a buffering agent to ensure that the final pH of the product does not vary widely. Examples of suitable buffering agents include Dolomite, Magnesium Sulphate and Gypsum. The amount of buffering agent used in each instance will depend on the additional ingredients added.

The media is typically produced by combining all ingredients in a blender and mixing until a thorough mixed blend of all ingredient is provided. It is then preferred that the blend is dried so that it has a moisture content of less than 25%, more preferably less than 18%. The blend is then preferably compressed into a block. A typical compression reduces the volume of the blend by a factor of about preferably 3 times, more preferably about 5 times. The advantage of being in the form of a compressed block is that the final product is very easy to handle from a logistical standpoint and thus attractive to consumers and retailers. In addition as it contains all necessary ingredients for a growth medium no further processing steps are required prior to use.

The invention will now be demonstrated with reference to the following example.

### EXAMPLE 1

A growth medium was produced by blending 15% fine grade coir, 35% 3-6 mm grade coir and 50% chip and fibre coir. This material was blended to produce a homogeneous mixture of the coir grades. To this was added a slow release fertilizer and a magnesium and calcium source. The magnesium and calcium source was dolomite and was added at a rate of 1 Kg. per 1000 L (prior to compression) and the amount of slow release added fertilizer was 3 Kg. per 1000 L. This material was then blended, compressed into the form of a block and packed for use.

### EXAMPLE 2

A growth medium was produced by blending 5% fine grade coir, 40% 3-6 mm grade coir and 55% chip and fibre coir. This material was blended to produce a homogeneous mixture of the coir grades. To this was added a slow release fertiliser and a magnesium and calcium source. The magnesium and calcium source was dolomite and was added at a rate of 1 Kg. per 1000 L (prior to compression) and the amount of slow release added fertiliser was 3 Kg. per 1000 L. This material was then blended, compressed into the form of a block and packed for use.

### EXAMPLE 3

A growth medium was produced by blending 5% fine grade coir, 25% 3-6 mm grade coir and 70% chip and fibre coir. This material was blended to produce a homogeneous mixture of the coir grades. To this was added a slow release fertiliser and a magnesium and calcium source. The magnesium and calcium source was dolomite and was added at a rate of 1 Kg. per 1000 L (prior to compression) and the amount of slow release added fertiliser was 3 Kg. per 1000 L. This material was then blended, compressed into the form of a block and packed for use.

### EXAMPLE 4

A growth medium was produced by blending 10% fine grade coir, 40% 3-6 mm grade coir and 50% chip and fibre coir. This material was blended to produce a homogeneous mixture of the coir grades. To this was added a slow release fertiliser and a magnesium and calcium source. The magnesium and calcium source was dolomite and was added at a rate of 1 Kg. per 1000 L (prior to compression) and the amount of slow release added fertiliser was 3 Kg. per 1000 L. This material was then blended, compressed into the form of a block and packed for use.

### EXAMPLE 5

A growth medium was produced by blending 5% fine grade coir, 15% 3-6 mm grade coir and 80% chip and fibre coir. This material was blended to produce a homogeneous mixture of the coir grades. To this was added a slow release fertiliser and a magnesium and calcium source. The magnesium and calcium source was dolomite and was added at a rate of 1 Kg. per 1000 L (prior to compression) and the amount of slow release added fertiliser was 3 Kg. per 1000 L. This material was then blended, compressed into the form of a block and packed for use.

### EXAMPLE 6

### Performance Testing

The growth medium of example 1 was compared in a side by side trial with a standard coir containing growth medium. It was found that plants grown using the growth medium of example 1 were typically 25% more vigorous than plants grown using the standard medium based on foliage growth.

### EXAMPLE 7

The growth media of examples 1, 2 and 3 were tested against standard cir based growth media for growing Gerberas. Gerberas were propagated under standard growing conditions using the growth media of each of examples 1, 2 and 3 and a control media. It was found that plants grown using the improved growth media of the invention typically produced an increase in flower production of 25% when compared to the standard.

### EXAMPLE 8

Roses were propagated in side by side study of the growth medium of examples 1 and 4 when compared to a standard growth medium containing coir. After propagation the roses were removed from the growth media and the root growth analysed. It was found that roses propagated using the growth medium of the invention exhibited significantly increased root growth when compared to the standard growth media.

Finally, it is to be understood that various alterations, modifications and/or additions may be introduced into the constructions and arrangements of parts previously described without departing from the spirit or ambit of the invention.

1. A growth medium including:
(a) fine grade coir, and
(b) coir having a particle size of at least 3 mm, wherein the fine grade coir is 40% or less of the total amount of coir in the medium, and wherein the amount of coir having a particle size of at least 3 mm is 60% or more of the total amount of coir in the medium.

2.-6. (canceled)

7. A growth medium according to claim 1 wherein the fine grade coir is 5% to 20% of the total amount of coir in the medium.

8.-15. (canceled)

16. A growth medium according to claim 1 wherein the amount of coir having a particle size of at least 3 mm is 80% to 95% of the total amount of coir in the medium.

17.-19. (canceled)

20. A growth medium according to claim 1 wherein the coir having a particle size of at least 3 mm is a mixture of 3-6 mm coir and chip and fibre coir.

21. A growth medium according to claim 20 wherein the amount of 3-6 mm coir is 10% to 50% of the total amount of coir in the medium.

22. (canceled)

23. A growth medium according to claim 20 wherein the amount of 3-6 mm coir is 15% to 45% of the total amount of coir in the medium.

24.-27. (canceled)

28. A growth medium according to claim 20 wherein the amount of Chip and fibre coir is 10% to 89% of the total amount of coir in the medium.

29.-31. (canceled)

32. A growth medium according to claim 20 wherein the amount of Chip and fibre coir is from 20% to 69% of the total amount of coir in the medium.

33.-34. (canceled)

35. A growth medium according to claim 1 wherein the coir in the medium is made up of (a) 1% to 25% fine grade coir, and (b) 75% to 99% coir having a particle size of at least 3 mm.

36. A growth medium according to claim 35 wherein the coir in the medium is made up of: (a) 1% to 25% fine grade coir, (b) 10% to 50% 3-6 mm grade coir, and (c) 25% to 89% chip and fibre coir.

37.-39. (canceled)

40. A growth medium according to claim 1 including:
5-15 parts of fine grade coir,
30 to 50 parts 3-6 mm grade coir,
40 to 60 parts chip and fibre coir,
wherein the total sum of the parts of fine grade coir, 3-6 mm grade coir, and chip and fibre coir add up to 100,

41.-45. (canceled)

46. A growth medium according to claim 1 including:
1 to 10 parts of fine grade coir,
30 to 50 parts 3-6 mm grade coir,
and 40 to 60 parts chip and fibre coir,
wherein the total sum of the parts of fine grade coir, 3-6 mm grade coir, and chip and fibre coir add up to 100,

47.-49. (canceled)

50. A growth medium according to claim 1 wherein the total amount of coir in the medium is at least 90%.

51.-52. (canceled)

53. A growth medium according to claim 1 wherein the medium contains one or more additives selected from the group consisting of wetting agents, trace elements, controlled release fertilisers, slow release fertilisers, fungicides, herbicides, insecticides, pigments, pH adjustment agents, buffers, humates, neem products and fungal additives.

54. A growth medium according to claim 1 wherein the medium contains a fertiliser.

55. (canceled)

56. A growth medium according to claim 54 wherein the amount of fertiliser is in the range of from 0.1% to 5%.

57.-58. (canceled)

59. A growth medium according to claim 1 wherein the medium contains a source of magnesium and calcium.

60. (canceled)

61. A growth medium according to claim 59 wherein the source of magnesium and calcium is present in an amount of 0.5% to 2%.

62.-64. (canceled)

65. A growth medium according to claim 1 wherein the medium is in the form of a compressed block and where the medium has been compressed by a factor of at least 3 when compared to the uncompressed volume of the medium prior to compression.

66. A growth medium according to claim 1 wherein the medium is in the form of a compressed block and where the growth medium has been compressed by a factor of at least 5 when compared to the uncompressed volume of the medium prior to compression.
